(19) United States
(12) Patent Application Publication
(10) Pub. No.: US 2023/0099371 A1
(43) Pub. Date: Mar. 30, 2023

(54) NON-AQUEOUS ELECTROLYTE SECONDARY BATTERY

(71) Applicant: Panasonic Intellectual Property Management Co., Ltd., Osaka-shi, Osaka (JP)

(72) Inventors: Takuji TSUJITA, OSAKA FU (JP); Keisuke ASAKA, OSAKA FU (JP); Motohiro SAKATA, OSAKA FU (JP)

(73) Assignee: Panasonic Intellectual Property Management Co., Ltd., Osaka-shi, Osaka (JP)

(21) Appl. No.: 17/913,761

(22) PCT Filed: Mar. 23, 2021
(86) PCT No.: PCT/JP2021/011951

§ 371 Date: Sep. 22, 2022

(30) Foreign Application Priority Data
Mar. 31, 2020 (JP) 2020-065083

(51) Int. Cl. H01M 10/0567; H01M 10/0525; H01M 4/505; H01M 4/525

(52) U.S. Cl. CPC H01M 10/0567; H01M 10/0525; H01M 4/505; H01M 4/525; H01M 2004/028

(57) ABSTRACT

A nonaqueous electrolyte secondary battery includes a positive electrode, a negative electrode, and a nonaqueous electrolyte, wherein the positive electrode includes a composite oxide containing lithium and a transition metal, and an additive covering at least a portion of a surface of the composite oxide. The additive includes a metal oxide and a phosphate compound, and the phosphate compound has at least one intramolecular alkenyl group.

### TECHNICAL FIELD

The present disclosure relates to a nonaqueous electrolyte secondary battery.

### BACKGROUND ART

Nonaqueous electrolyte secondary batteries represented by lithium ion secondary batteries have high energy density and high output, and expected to be promising as a power supply of mobile devices such as smart-phones, a power source of a vehicle such as an electric vehicle, and a storage device of natural energy such as sunlight. As the positive electrode active material of a nonaqueous electrolyte secondary battery, for example, a composite oxide containing lithium and a transition metal is used.

Patent Literature 1 has proposed forming a cover layer containing a metal oxide, and a compound including Li and P at a surface of a composite oxide containing lithium and a transition metal, i.e., a positive electrode active material of a nonaqueous electrolyte secondary battery. The above-described metal oxide includes at least one metal element selected from the group consisting of Group 3 elements, Group 13 elements, and lanthanoids (hereinafter, referred to as lanthanoid, and the like) of the periodic table. Examples of the compound including Li and P include Li₃PO₄, Li₄P₂O₇, and Li₃PO₃ (hereinafter, referred to as Li₃PO₄, and the like).

### CITATION LIST

### Patent Literature

PLT1: WO2013/047877

### SUMMARY OF INVENTION

The above-described cover layer is formed by a liquid phase method, in which a composite oxide is allowed to contact raw material solutions (a first aqueous solution including lanthanoid and the like and a second aqueous solution including P), and then heated, and the cover layer including an oxide of lanthanoids and the like and Li₃PO₄ and the like is formed in a form of islands. This is due to differences in the densities of the raw material and the product during heating, degree of sintering of the product, and gas generation involved with decomposition reaction of the material in the raw material solutions.

When the cover layer is formed in the island form, the coverage of the composite oxide becomes insufficient, and the nonaqueous electrolyte can make contact with the composite oxide to cause decomposition, which may cause reduction in cycle characteristics.

In view of the above, an aspect of the present disclosure relates to a nonaqueous electrolyte secondary battery including a composite oxide containing lithium and a transition metal, and an additive covering at least a portion of a surface of the composite oxide; the additive includes a metal oxide and a phosphate compound; and the phosphate compound has at least one intramolecular alkenyl group.

The present disclosure allows for improvement in cycle characteristics of nonaqueous electrolyte secondary batteries.

### BRIEF DESCRIPTION OF DRAWINGS

FIG. 1 is a partially cutaway oblique perspective view of a nonaqueous electrolyte

### DESCRIPTION OF EMBODIMENTS

A nonaqueous electrolyte secondary battery of an embodiment of the present disclosure includes a composite oxide containing lithium and a transition metal (positive electrode active material), and an additive covering at least a portion of a surface of the composite oxide. The additive includes a metal oxide and a phosphate compound (hereinafter, also referred to as compound A) having at least one intramolecular alkenyl group.

When the additive covering the surface of the composite oxide includes the metal oxide and the compound A, the surface of the composite oxide is sufficiently and stably covered with the additive. In this manner, decomposition due to contacts between the nonaqueous electrolyte and composite oxide is suppressed, and cycle characteristics improve.

The surface of the composite oxide is covered with a metal oxide in an island form, and has a region not covered with the metal oxide. The region not covered with the metal oxide is covered with the compound A. By covering the region not covered with the metal oxide with the compound A to supplement, the coverage of the composite oxide surface with the additive improves, and contacts between the nonaqueous electrolyte and the composite oxide are sufficiently suppressed.

By covering with a thin layer (e.g., thickness 1 nm or more and 5 nm or less) of metal oxide, and further covering with the compound A, coverage of the composite oxide surface with the additive can be further improved. Thus, the following disadvantage can be avoided. The disadvantage is that using a large amount of metal oxide to improve the coverage increases the metal oxide coating layer thickness, which increases the resistance. With a small amount of metal oxide and compound A, the composite oxide surface can be efficiently covered with a thin layer. Thus, a battery with a small internal resistance and excellent cycle characteristics can be easily obtained.

Specific reasons why the use of the compound A allows for improvement in the coverage of the composite oxide surface are not clear, but interactions between the alkenyl group (carbon-carbon double bond) of the compound A and the transition metal in the composite oxide are probably one of the factors for improvement in the coverage.

### Compound A

The compound A is phosphate (organic phosphoric acid) having at least one intramolecular alkenyl group, and can be easily included by dissolving the compound A in the nonaqueous electrolyte used for the battery. It is advantageous in terms of productivity because the nonaqueous electrolyte including the compound A can be prepared during battery production, and the coverage of the composite oxide surface with the compound A can be easily achieved using the nonaqueous electrolyte.

In view of the interaction with the transition metal in the composite oxide, the carbon-carbon double bond in the alkenyl group is preferably near the distal end of the alkenyl group. In view of easily dissolving the compound A in the nonaqueous electrolyte, easily attaching the compound A to the region not covered with the metal oxide of the composite oxide surface, and suitably adjusting the viscosity of the nonaqueous electrolyte including the compound A to low, the alkenyl group preferably has, for example, 2 or more and 5 or less carbon atoms. From the same viewpoint, the alkenyl group preferably is linear. When the compound A has a plurality of alkenyl groups, the plurality of alkenyl groups may be the same, or may be different from each other.

Specifically, the alkenyl group may include at least one selected from the group consisting of a vinyl group, a 1-propenyl group, a 2-propenyl group (allyl group), an isopropenyl group, a 1-butenyl group, a 2-butenyl group, and a 3-butenyl group. In view of easily dissolving the compound A in the nonaqueous electrolyte, easily attaching the compound A to the region not covered with the metal oxide of the composite oxide surface, and easily and suitably adjusting the viscosity of the nonaqueous electrolyte including the compound A to low, in particular, the alkenyl group is preferably an allyl group or a 3-butenyl group, and the allyl group is more preferable.

The compound A has, for example, a structure represented by a formula (I) below.

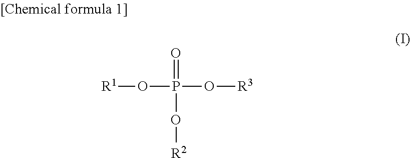

In the formula (I), at least one of R¹, R², and R³ is an alkenyl group. Preferably, all of R¹, R², and R³ is an alkenyl group. When the compound A represented by the formula (I) has a plurality of alkenyl groups, the plurality of alkenyl groups may be the same, or may be different from each other. The hydrogen atom included in the alkenyl group can be partially replaced with a halogen atom such as a chlorine atom. The alkenyl group has, for example, 2 or more and 5 or less carbon atoms. The alkenyl group may be linear or branched. The alkenyl group may have a structure represented by CH₂═CH—(CH₂)ₙ—. Preferably, n is 0 or more and 3 or less, more preferably n=1.

In the formula (I), one or two of R¹, R², and R³ may be a hydrocarbon group other than the alkenyl group. The hydrocarbon group other than the alkenyl group includes an alkyl group and the like. The hydrogen atom included in the hydrocarbon group (alkyl group, etc.) other than the alkenyl group may be partially replaced with a halogen atom such as a chlorine atom and the like. When the compound A represented by the formula (I) has two hydrocarbon groups other than the alkenyl group, the hydrocarbon groups other than the alkenyl group may be the same, or may be different from each other. The alkyl group has, for example, 2 or more and 5 or less carbon atoms. The alkyl group may be linear or branched. The alkyl group may be a methyl group, an ethyl group, a propyl group, and the like.

The compound A includes phosphoric acid monoester, phosphoric acid diester, and phosphoric acid triester, and in particular, phosphoric acid triester is preferable. Preferably, phosphoric acid triester includes triallyl phosphate. With a small amount of triallyl phosphate, the resistance of the positive electrode can be minimized, while efficiently improving coverage of the composite oxide with its surface covered with metal oxide. Furthermore, triallyl phosphate can be easily dissolved in nonaqueous electrolytes, which makes it easier to prepare a nonaqueous electrolyte with a low viscosity.

The nonaqueous electrolyte may contain the compound A by 2 mass % or less, 0.25 mass % or more and 2 mass % or less, or 0.25 mass % or more and 1.25 mass % or less relative to the entire nonaqueous electrolyte. For example, at the time of the nonaqueous electrolyte preparation (before injection into battery), the compound A is contained within the above-described range. In this case, the region not covered with the metal oxide on the composite oxide surface can be sufficiently covered with the compound A, which allows for improvement in cycle characteristics easily.

When the compound A is contained by 2 mass % or less at the time of nonaqueous electrolyte preparation, the compound A is contained in the nonaqueous electrolyte in an initial battery (e.g., after injection of nonaqueous electrolyte or after several charge/discharge), by for example, 1 mass % or less, or 100 ppm or less, or a trace amount of near detection limit. As long as the presence of the compound A can be confirmed in the nonaqueous electrolyte in the battery, the compound A derived from the nonaqueous electrolyte is assumed to be attached to the composite oxide to some extent, and improvement effects of cycle characteristics to that extent can be recognized. The compound A content in the nonaqueous electrolyte can be determined by gas chromatograph mass spectrometry (GC/MS) and the like.

### Metal Oxide

The metal oxide covering the composite oxide surface does not serve as a positive electrode active material, unlike the composite oxide used as the positive electrode active material, but has lithium ion conductivity. The metal oxide includes metal Mc. The metal Mc may include at least one selected from the group consisting of aluminum, silicon, titanium, magnesium, zirconium, niobium, germanium, calcium, and strontium. More specifically, the metal oxide may include at least one selected from the group consisting of aluminum oxide, silicon oxide, titanium oxide, magnesium oxide, zirconium oxide, niobium oxide, germanium oxide, calcium oxide, and strontium oxide. The aluminum oxide includes alumina (Al₂O₃) and the like. The silicon oxide includes silica (SiO₂) and the like. The titanium oxide includes TiO₂ and the like. The magnesium oxide includes MgO and the like. The zirconium oxide includes ZrO₂ and the like. The metal oxide may include silica alumina (composite oxide including aluminum and silicon).

In particular, in view of the fact that it is advantageous in terms of costs, and it is excellent in lithium ion conductivity, chemical stability, and thermal stability, the metal oxide preferably includes at least one selected from the group consisting of aluminum oxide, silicon oxide, and silica alumina.

In view of improvement in coverage of the composite oxide surface with the compound A, the amount covered with metal oxide (cover layer thickness) can be made small. The metal oxide cover layer has a thickness of, for example, a small thickness in a range of 1 nm or more and 5 nm or less. When the metal oxide cover layer has a thickness of 5 nm or less, migration of lithium ions between the composite oxide and the nonaqueous electrolyte through the metal oxide cover layer can be smoothly conducted, and a high capacity and excellent cycle characteristics can be easily obtained. In view of the amount of the composite oxide to be included in the positive electrode (positive electrode capacity), the metal oxide cover layer may have a thickness of 1 nm or more and 3 nm or less.

When the surface of the nickel-based composite oxide represented by a general formula (2) described later is covered with Al₂O₃, at the outermost surface of the composite oxide, the atomic ratio of Al derived from the metal oxide relative to Ni derived from the composite oxide: Al/Ni is, for example, 2 or less. In this case, at the surface of the composite oxide, a thin layer of metal oxide (e.g., thickness 1 nm or more and 3 nm or less) is presumably distributed in an island form.

The distribution state of the metal Mc derived from the metal oxide and P derived from the compound A can be checked by performing element analysis (element mapping) on cross sections of the positive electrode mixture layer or composite oxide using an electron beam probe micro analyzer (EPMA) or energy dispersive X-ray (EDX) analyzer.

### Composite Oxide

The positive electrode active material includes a composite oxide containing lithium and a metal Me other than lithium. The metal Me includes at least a transition metal. The transition metal may include at least one element selected from the group consisting of nickel (Ni), cobalt (Co), manganese (Mn), iron (Fe), copper (Cu), chromium (Cr), titanium (Ti), niobium (Nb), zirconium (Zr), vanadium (V), tantalum (Ta), and molybdenum (Mo).

The composite oxide is synthesized by using coprecipitation, and for example, obtained by mixing a lithium compound with a compound containing a metal Me other than lithium obtained by coprecipitation, and baking the obtained mixture under predetermined conditions. The composite oxide is generally forming secondary particles, i.e., a plurality of coagulated primary particles. The composite oxide particles have an average particle size (D50) of, for example, 3 μm or more and 25 μm or less. The average particle size (D50) of the composite oxide particles means a particle size (volume average particle size) at a volume integrated value of 50% in the volume-based particle size distribution measured by the laser diffraction scattering method.

The metal Me may include a metal other than a transition metal. The metal other than the transition metal may include at least one selected from the group consisting of aluminum (Al), magnesium (Mg), calcium (Ca), strontium (Sr), zinc (Zn), and silicon (Si). In addition to the metal, the composite oxide may further include boron (B) or the like.

In view of achieving a high capacity, the transition metal preferably includes at least Ni. The metal Me may include Ni and at least one selected from the group consisting of Co, Mn, Al, Ti, and Fe. In view of increasing the capacity and output, among others, the metal Me preferably contains Ni and at least one selected from the group consisting of Co, Mn, and Al, and more preferably contains Ni, Co, and Mn and/or Al. When the metal Me contains Co, the phase transition of the composite oxide containing Li and Ni is suppressed during charge and discharge, the stability of the crystal structure is improved, and the cycle characteristics are easily improved. When the metal Me contains Mn and/or Al, the thermal stability is improved.

In view of easily achieving a high capacity, in the composite oxide, the atomic ratio of Ni relative to metal Me: Ni/Me may be 0.3 or more and less than 1, preferably 0.5 or more and less than 1, more preferably 0.75 or more and less than 1.

In view of improving cycle characteristics and obtaining higher output, the positive electrode active material may include a composite oxide having a layered rock salt type crystal structure and containing Ni and/or Co, or a composite oxide having a spinel type crystal structure and containing Mn. In view of obtaining a higher capacity, in particular, it may be a composite oxide (hereinafter, also referred to as nickel-based composite oxide) having a layered rock salt type crystal structure and containing Ni, and having an atomic ratio of Ni relative to metal Me: Ni/Me of 0.3 or more.

The nickel-based composite oxide has a relatively unstable crystal structure, is prone to deterioration due to elution of Ni caused by contacts with the nonaqueous electrolyte in a high potential positive electrode, and easily reduces cycle characteristics. Thus, in the case of the nickel-based composite oxide, improvement effects of cycle characteristics by the coverage of the composite oxide surface with the additive including the compound A and metal oxide are significant. With the above-described coverage, the high capacity owned by the nickel-based composite oxide can be sufficiently brought out.

The composite oxide may have a composition having a layered rock salt type crystal structure, and represented by a general formula (1): LiNi_{α}M_{1-α}O₂(0.3<α<1 is satisfied, and M is at least one element selected from the group consisting of Co, Mn, Al, Ti, and Fe). When α is in the above-described range, the effect of Ni and the effect of element M can be obtained in a well-balanced manner. A may be 0.5 or more, or 0.75 or more.

In view of obtaining improvement in cycle characteristics, a higher capacity and higher output, the composite oxide may have a composition having a layered rock salt type crystal structure and represented by a general formula (2): LiNiₓCo_{y}M_{1-x-y}O₂, where in the general formula (2), 0.3≤x<1, 0<y≤0.5, and 0<1-x-y≤0.35 are satisfied, and M is at least one selected from the group consisting of Al and Mn. The value of x may be in the range of 0.5≤x<1. The value of y may be in the range of 0<y≤0.35.

### Covering Method of Composite Oxide Surface with Additive

The covering method of the composite oxide surface with the additive includes, for example, a first step, in which the composite oxide surface is covered with a metal oxide; and a second step, in which the composite oxide surface covered with the metal oxide is covered with the compound A. In the first step, the composite oxide surface is covered with the metal oxide in an island form, and the composite oxide surface has a region not covered with the metal oxide. In the second step, the region not covered with the metal oxide of the composite oxide surface is covered with the compound A. The metal oxide may be partially covered thinly with the compound A. Thus, the composite oxide surface is sufficiently covered with the additive including metal oxide and the compound A, and contacts between the composite oxide and the nonaqueous electrolyte can be sufficiently suppressed.

### First Step

In the first step, the composite oxide surface is covered with a metal oxide by a liquid phase method or a gas phase method. Examples of the liquid phase method include spray coating, and dip coating. Examples of the gas phase method include chemical vapor deposition (CVD), and atomic layer deposition (ALD).

The first step includes, for example, a step (1A), in which a positive electrode mixture layer including a composite oxide is formed on the positive electrode current collector; and a step (1B), in which the positive electrode mixture layer surface is covered with a metal oxide to produce a positive electrode intermediate.

In the step (1A), for example, a positive electrode slurry in which a positive electrode mixture is dispersed in a dispersion medium is applied on the positive electrode current collector surface, and dried. The dried coating film may be rolled, if necessary. The positive electrode mixture layer may be formed on one surface of the positive electrode current collector, or may be formed on both surfaces thereof. The positive electrode mixture includes at least a composite oxide, and may further include a binder, conductive agent, and the like. Examples of the dispersion medium include N-methyl-2-pyrrolidone (NMP).

Examples of the binder include resin materials such as, for example, fluororesin, polyolefin resin, polyamide resin, polyimide resin, acrylic resin, and vinyl resin. Examples of the fluororesin include polytetrafluoroethylene (PTFE), and polyvinylidene fluoride (PVDF). A kind of binder may be used singly, or two or more kinds thereof may be used in combination.

Examples of the conductive agent include carbon blacks such as acetylene black; conductive fibers such as carbon fibers and metal fibers; and carbon fluoride. A kind of conductive agent may be used singly, or two or more kinds thereof may be used in combination.

As the positive electrode current collector, for example, a metal foil can be used. Examples of the metal composing the positive electrode current collector include aluminum, titanium, alloys including any of these metal elements, and stainless steel. The thickness of the positive electrode current collector is not particularly limited, but is, for example, 3 to 50 μm.

Preferably, in the step (1B), a thin layer of metal oxide is formed on the positive electrode mixture layer surface by a gas phase method. Preferably, the gas phase method is an ALD method. By forming a thin layer of metal oxide, it allows the composite oxide to smoothly store and release lithium ions. The metal oxide cover layer can be formed thinly in an island form depending on the temperature at the time of film forming and the amount of the metal oxide deposited by the ALD. Even if the metal oxide cover layer is formed in an island form, in the second step, the compound A allows for improved coverage of the composite oxide surface.

The ALD method is a film forming method in which a raw material gas including a metal Mc (Al and the like) and an oxidizer are alternately supplied to a reaction chamber in which the target is disposed to form a layer including an oxide of the metal Mc on the target surface. In the ALD method, self-limiting works, and therefore deposition by an atomic layer is made on the surface of the target. Therefore, the thickness of the metal oxide layer is controlled by the number of cycles, setting the following as 1 cycle: the supply of the raw material gas→exhaust (purge) of the raw material gas→supply of oxidizer→exhaust (purge) of the oxidizer. That is, the ALD allows for easy controlling of the thickness of the metal oxide layer to be formed.

Generally, CVD is performed under the temperature conditions of 400 to 900° C., while ALD can be performed under the temperature conditions of 100 to 400° C. That is, the ALD is excellent in that it can suppress thermal damages to the electrode. Examples of the oxidizer used in the ALD include water, oxygen, and ozone. The oxidizer may be supplied to the reaction chamber as a plasma using an oxidizer as a raw material.

The Al and the like are supplied to the reaction chamber as a precursor gas including Al and the like. The precursor is, for example, an organometallic compound including Al and the like, and in this manner, the Al and the like are easily adsorbed chemically to the target. As the precursor, various types of organometallic compound conventionally used in the ALD method can be used. Examples of the precursor including Al include trimethyl aluminum ((CH₃)Al), and triethyl aluminum ((C₂H₅)₃Al).

The first step may include a step (1a), in which the surface of the composite oxide is covered with metal oxide; and a step (1b), in which a positive electrode mixture layer including the composite oxide with its surface covered with metal oxide is formed on the positive electrode current collector surface to obtain a positive electrode intermediate.

In the step (1a), for example, a liquid phase method is used. The step (1a) includes, for example, a step (1a-1), in which a raw material solution is attached to the composite oxide surface; and a step (1a-2), in which the composite oxide having the surface attached with the raw material solution is heated and dried. In the step (1a-1), for example, a composite oxide is added to the raw material solution, and dispersed by stirring. The step (1a-2) serves as a step of removing the dispersion medium attached to the composite oxide surface by heating and drying, and a step of producing a metal oxide by allowing the raw material attached to the composite oxide surface to react. For the raw material solution, for example, an aqueous solution including a raw material containing a metal Mc is used. For the raw material containing the metal Mc, a compound that can produce a metal oxide by decomposition reaction by heating, and for example, a salt of metal Mc of organic acids such as citric acid, maleic acid, lactic acid, etc., and an organic metal complex including metal Mc is used. In the step (1a-2),the metal oxide cover layer may be formed thinly and in an island form. Even if the metal oxide cover layer is formed in an island form, in the second step, the compound A allows for improved coverage of the composite oxide surface.

In the step (1b), for example, a positive electrode slurry in which a positive electrode mixture including a composite oxide with its surface covered with the metal oxide is dispersed in a dispersion medium is applied on the positive electrode current collector surface and dried. The positive electrode mixture may further include a binder, a conductive agent, and the like. For the binder, conductive agent, dispersion medium, and positive electrode current collector, those exemplified in the step (1A) may be used.

### Second Step

Preferably, the second step includes a step (2A), in which a nonaqueous electrolyte including compound A is prepared; and a step (2B), in which the nonaqueous electrolyte including compound A is allowed to contact with the composite oxide with its surface covered with the metal oxide. In the step (2B), the region not covered with the metal oxide of the composite oxide surface is covered with the compound A. The compound A is organic phosphoric acid, and therefore the compound A can be easily dissolved in the nonaqueous electrolyte to be included. By using the nonaqueous electrolyte including the compound A in battery production processes, the composite oxide surface can be easily covered with the compound A, which is advantageous in terms of improvement in productivity. In the step (2B), for example, an electrode group including the positive electrode intermediate obtained in the step (1B) or the step (1b), a negative electrode, and a separator interposed between the positive electrode intermediate and the negative electrode is composed, and the electrode group may be allowed to include a nonaqueous electrolyte. For example, the electrode group is accommodated in a battery case, and a nonaqueous electrolyte may be injected into the battery case accommodating the electrode group, and the opening of the battery case is sealed with a sealing plate.

In the case of the positive electrode intermediate obtained in the step (1B), by the step (2B), the surface of the positive electrode mixture layer covered with the metal oxide can be further covered with the compound A. In the case of the positive electrode intermediate obtained in the step (1b), by the step (2B), the surface of the composite oxide covered with the metal oxide can be further covered with the compound A. The covering with the compound A is performed after formation of the positive electrode mixture layer, and therefore contact points between the composite oxide particles can be easily formed without the compound A interposed therebetween, and conductive network can be easily ensured between the composite oxide particles.

Hereinafter, the configuration of the nonaqueous electrolyte secondary battery will be described more specifically.

### Positive Electrode

The positive electrode may include, for example, a positive electrode current collector and a positive electrode mixture layer supported on the surface of the positive electrode current collector, and a positive electrode mixture layer including at least the composite oxide. The positive electrode mixture layer may further include the above-described conductive agent and binder. The surface of the composite oxide included in the positive electrode mixture layer may be covered with the additive including a metal oxide and a compound A. The surface of the positive electrode mixture layer including the composite oxide may be covered with the additive including the metal oxide and the compound A.

### Negative Electrode

The negative electrode may include a negative electrode current collector and a negative electrode mixture layer supported on the surface of the negative electrode current collector. The negative electrode mixture layer can be formed, for example, by applying a negative electrode slurry in which the negative electrode mixture is dispersed in a dispersion medium on a surface of the negative electrode current collector and drying the slurry. The dried coating film may be rolled, if necessary. The negative electrode mixture layer may be formed on one surface of the negative electrode current collector, or on both surfaces thereof. As the dispersion medium, for example, water or NMP is used.

The negative electrode mixture contains a negative electrode active material as an essential component, and may contain a binder, a conductive agent, a thickener, and the like as an optional component. As the binder and the conductive agent, those exemplified for the positive electrode can be used. For the binder, rubber materials such as a styrene-butadiene copolymer rubber (SBR) and the like may be used. Examples of the thickener include carboxymethylcellulose (CMC) and a modified product thereof (such as Na salts).

The negative electrode active material may contain a carbon material which absorbs and releases lithium ions. Examples of the carbon material for absorbing and releasing lithium ions include graphite (natural graphite, artificial graphite), soft carbon, and hard carbon. Preferred among them is graphite, which is excellent in stability during charging and discharging and has a small irreversible capacity.

The negative electrode active material may include an alloy-based material. The alloy-based material is a material containing at least one kind of metal capable of forming an alloy with lithium, and includes, for example, silicon, tin, a silicon alloy, a tin alloy, a silicon compound, and the like. For the silicon compound, a composite material having a lithium ion conductive phase and silicon particles dispersed in the phase may be used. As the lithium ion conductive phase, a silicate phase such as a lithium silicate phase, a silicon oxide phase in which 95 mass % or more is silicon dioxide, a carbon phase, or the like may be used.

As the negative electrode active material, the alloy-based material and the carbon material can be used in combination. In this case, the ratio of the carbon material to the total of the alloy-based material and the carbon material is, for example, preferably 80 mass % or more, and more preferably 90 mass % or more.

The shape and thickness of the negative electrode current collector can be selected from the shapes and ranges according to the positive electrode current collector. As a metal composing the negative electrode current collector, for example, copper (Cu), nickel (Ni), iron (Fe), and an alloy containing any of these metal elements can be used.

### Nonaqueous Electrolyte

The nonaqueous electrolyte contains a nonaqueous solvent, and a lithium salt dissolved in the nonaqueous solvent. The nonaqueous electrolyte may contain the compound A. The compound A contained in the nonaqueous electrolyte may be attached to the composite oxide surface, and the composite oxide surface may be covered with the compound A. Preferably, the lithium salt concentration of the nonaqueous electrolyte is, for example, 0.5 mol/L or more and 2 mol/L or less. With the lithium salt concentration set to be within the above-described range, a nonaqueous electrolyte having an excellent ion conductivity and a suitable viscosity can be produced. However, the lithium salt concentration is not limited to the above-described concentration.

As the nonaqueous solvent, for example, a cyclic carbonate, a chain carbonate, a cyclic carboxylate, a chain carboxylate, or the like is used. Examples of the cyclic carbonate include propylene carbonate (PC), ethylene carbonate (EC), and the like. The cyclic carbonate may include fluorinated cyclic carbonate including fluoroethylene carbonate (FEC), and cyclic carbonate having a carbon-carbon unsaturated bond such as vinylene carbonate (VC), and vinyl ethylene carbonate. Examples of the chain carbonate include diethyl carbonate (DEC), ethyl methyl carbonate (EMC), dimethyl carbonate (DMC), and the like. Examples of the cyclic carboxylate include γ-butyrolactone (GBL) and γ-valerolactone (GVL). Examples of the chain carboxylate include methyl formate, ethyl formate, propyl formate, methyl acetate, ethyl acetate, propyl acetate, methyl propionate, ethyl propionate, and propyl propionate. A kind of nonaqueous solvent may be used singly, or two or more kinds thereof may be used in combination.

Examples of the lithium salt include known lithium salts. Examples of the preferable lithium salt include LiClO₄, LiBF₄, LiBF₆, LiPF₆, LiAlCl₄, LiSbF₆, LiSCN, LiCF₃SO₃, LiCF₃CO₂, LiAsF₆, LiB₁₀Cl₁₀, lithium lower aliphatic carboxylate, LiCl, LiBr, LiI, borates, and imide salts. Examples of the borates include bis(1,2-benzenediolate (2-)—O,O′) lithium borate, bis(2,3-naphthalenediolate (2-)—O,O′) lithium borate, bis(2,2′-biphenyldiolate (2-)—O,O′) lithium borate, and bis(5-fluoro-2-olate-1-benzenesulfonic acid-O,O′) lithium borate. Examples of the imide salts include lithium bis(fluorosulfonyl) imide (LiN(FSO₂)₂), lithium bis(trifluoromethyl sulfonyl) imide (LiN(CF₃SO₂)₂), lithium trifluoromethyl sulfonyl nonafluorobutyl sulfonyl imide (LiN(CF₃SO₂) (C₄F₉SO₂)), and lithium bis(pentafluoroethyl sulfonyl) imide (LiN(C₂F₅SO₂)₂). A kind of lithium salt may be used singly, or two or more kinds thereof may be used in combination.

### Separator

Usually, it is desirable to interpose a separator between the positive electrode and the negative electrode. The separator may include the nonaqueous electrolyte including the compound A. The separator has excellent ion permeability and suitable mechanical strength and electrically insulating properties. The separator may be, for example, a microporous thin film, a woven fabric, or a nonwoven fabric. The separator is preferably made of, for example, polyolefin such as polypropylene and polyethylene.

In an example structure of the nonaqueous electrolyte secondary battery, an electrode group and a nonaqueous electrolyte are accommodated in an outer package, and the electrode group has a positive electrode and a negative electrode wound with a separator interposed therebetween. Alternatively, instead of the wound-type electrode group, other forms of electrode groups may be applied, such as a laminated electrode group in which the positive electrode and the negative electrode are laminated with a separator interposed therebetween. The nonaqueous electrolyte secondary battery may be any shape of, for example, a cylindrical shape, a rectangular shape, a coin-shape, a button shape, or a laminate shape.

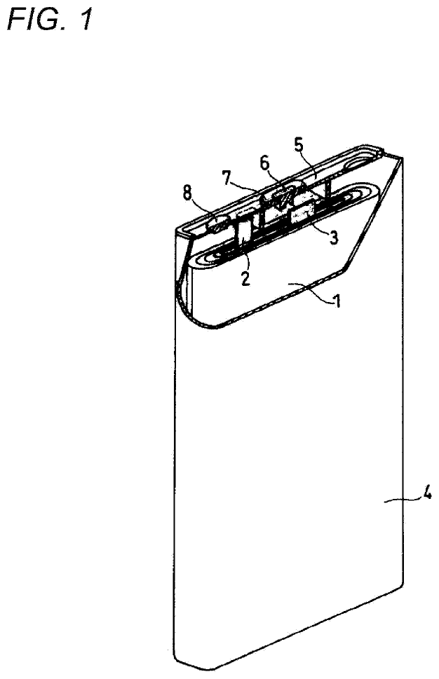

FIG. 1 is a schematic oblique cutaway view of a nonaqueous electrolyte secondary battery of an embodiment of the present disclosure.

The battery includes a bottomed rectangular battery case 4, and an electrode group 1 and a nonaqueous electrolyte accommodated in the battery case 4. The electrode group 1 has a negative electrode in the form of a long strip, a positive electrode in the form of a long strip, and a separator interposed therebetween for preventing direct contact therebetween. The electrode group 1 is formed by winding the negative electrode, the positive electrode, and the separator around a flat core and removing the core.

One end of a negative electrode lead 3 is attached to a negative electrode current collector of the negative electrode by welding or the like. The other end portion of the negative electrode lead 3 is electrically connected to a negative electrode terminal 6 provided in a sealing plate 5 through a resin insulating plate. The negative electrode terminal 6 is insulated from the sealing plate 5 by a resin gasket 7. To a positive electrode current collector of the positive electrode, one end of a positive lead 2 is attached by welding or the like. The other end of the positive lead 2 is connected to the rear surface of the sealing plate 5 through a resin insulating plate. That is, the positive electrode lead 2 is electrically connected to the battery case which also serves as the positive electrode terminal. The insulating plate separates the electrode group 1 and the sealing plate 5 and separates the negative electrode lead 3 and the battery case 4. The periphery of the sealing plate 5 is fitted to the open end of the battery case 4, and the fitting portion is laser welded. In this manner, the opening of the battery case 4 is sealed by the sealing plate 5. The injection hole for the nonaqueous electrolyte provided in the sealing plate 5 is plugged by a sealing plug 8.

In the following, the present disclosure will be described in detail based on Examples and Comparative Examples, but the present invention is not limited to Examples below.

### EXAMPLES 1 TO 4

### Positive Electrode Intermediate Production

To the positive electrode mixture, N-methyl-2-pyrrolidone (NMP) was added, and stirred to prepare a positive electrode slurry. As the positive electrode mixture, a mixture of a positive electrode active material, acetylene black (AB), and polyvinylidene fluoride (PVDF) was used. Layered rock salt type composite oxide particles (average particle size (D50) 4 μm) having a composition of LiNi_{0.35}Co_{0.35}Mn_{0.30}(NCM) was used for the positive electrode active material. In the positive electrode mixture, the mass ratio of the positive electrode active material, AB, and PVDF was set to 100:2:2.

The positive electrode slurry was applied to a surface of an aluminum foil, dried and rolled to form a positive electrode mixture layer. The positive electrode mixture layer was formed on both sides of the aluminum foil. Furthermore, the surface of the positive electrode mixture layer was covered with Al₂O₃ by ALD (temperature: 120° C., precursor: trimethyl aluminum, oxidizer: H₂O, pressure: a few Torr, 10 cycles). A positive electrode intermediate was produced in this manner. The atomic ratio Al/Ni at the outermost surface of the positive electrode intermediate determined by the above described method was 2 or less.

### Negative Electrode Production

Water was added to the negative electrode mixture and stirred to prepare a negative electrode slurry. A mixture of artificial graphite (average particle size 20 μm), styrene-butadiene rubber (SBR), and sodium carboxymethyl cellulose (CMC-Na) was used for the negative electrode mixture. In the negative electrode mixture, the mass ratio of artificial graphite, SBR, and CMC-Na was set to 100:1:1. A negative electrode slurry was applied to a surface of copper foil, dried and then rolled to form a negative electrode having a negative electrode mixture layer on both sides of the copper foil.

### Nonaqueous Electrolyte Preparation

LiPF₆ was dissolved in a solvent mixture (volume ratio 2:8) of fluoro ethylene carbonate (FEC) and dimethyl carbonate (DMC), and triallyl phosphate (TP) was further added, thereby producing a nonaqueous electrolyte. The nonaqueous electrolyte had a LiPF₆ concentration of 1 mol/L. The nonaqueous electrolyte had a TP content (mass ratio relative to the entire nonaqueous electrolyte) value shown in Table 1.

### Nonaqueous Electrolyte Secondary Battery Production

An Al made positive electrode lead was attached to the positive electrode intermediate produced as described above. A Ni-made negative electrode lead was attached to the negative electrode produced as described above. The positive electrode intermediate and the negative electrode were wound with a polyethylene thin film (separator) interposed therebetween into a spiral shape in an inert gas atmosphere, thereby producing a wound-type electrode group. The electrode group was accommodated in a bag-type outer package formed of a laminate sheet including an Al layer, the above-described nonaqueous electrolyte was injected, and then the outer package was sealed, thereby producing a nonaqueous electrolyte secondary battery. Upon accommodating the electrode group in the outer package, a portion of the positive electrode lead and a portion of the negative electrode lead were allowed to be exposed to the outside of the outer package. In the battery, the positive electrode intermediate was allowed to contact the nonaqueous electrolyte (TP) to further cover the positive electrode mixture layer surface with TP, thereby producing a positive electrode. In Table 1, the batteries of Examples 1 to 4 correspond to Al to A4, respectively.

### Comparative Example 1

In the positive electrode intermediate production, both sides of the positive electrode mixture layer were not covered with Al₂O₃. In the nonaqueous electrolyte preparation, the nonaqueous electrolyte did not contain TP. Except for the above, a battery B1 was produced in the same manner as in the battery Al of Example 1.

### Comparative Example 2

A battery B2 was produced in the same manner as in the battery Al of Example 1, except that in the nonaqueous electrolyte preparation, the nonaqueous electrolyte did not contain TP.

### Comparative Example 3

A battery B3 was produced in the same manner as in the battery A2 of Example 2, except that in the positive electrode intermediate production, both sides of the positive electrode mixture layer were not covered with Al₂O₃.

The batteries A1 to A4 of Examples 1 to 4 and batteries B1 to B3 of Comparative Examples 1 to 3 were evaluated as below.

### Evaluation 1: Capacity Retention Rate at 15 1st Cycle

### (1) First Charge/Discharge

Constant current charging was performed at a current of 0.2 C until the voltage reached 4.5 V, and then constant voltage charging was performed at a voltage of 4.5 V until the electric current reached 0.05 C. Afterwards, constant current discharging was performed until the voltage reached 2.5 Vat a current of 0.2 C. The batteries were allowed to rest for 60 minutes between the charging and discharging. The charge/discharge were conducted under an environment of 25° C.

### (2) Second Charge/Discharge

Constant current charging was performed at a current of 0.3 C until the voltage reached 4.5V, and then constant current discharging was performed at a current of 0.5 C until the voltage reached 2.5 V. The batteries were allowed to rest for 10 minutes between the charging and discharging. The charge/discharge were conducted under an environment of 25° C.

### (3) Measurement of Capacity Retention Rate at 15 1st Cycle

After the 1st cycle of the above-described first charge/discharge (1), the second charge/discharge (2) of the above-described was performed for 24 cycles: this as 1 set, 6 sets were performed. That is, for the 1st cycle, 26th cycle, 51st cycle, 76th cycle, 101st cycle, 126th cycle, and 15 1st cycle, the above-described first charge/discharge (1) was performed. For the cycle other than the above-described cycle, the above-described second charge/discharge (2) was performed. The ratio of the discharge capacity at the 1st cycle in the first charge/discharge relative to the discharge capacity at the 15 1st cycle in the first charge/discharge was determined as the capacity retention rate at the 15 1st cycle.

### Evaluation 2: Internal Resistance at 10 1st Cycle

The batteries A3 and the batteries B1 to B3 after the first charge/discharge in the 10 1st cycle were charged to 50% of the full charge. Afterwards, constant current discharging was performed for 30 seconds at an electric current I of 0.3 C, and a voltage drop ΔV from the discharge start to 30 seconds after the discharge start was measured to calculate ΔV/I to be regarded as an internal resistance.

The evaluation results are shown in Table 1.

TABLE 1

| | TP Content | Additive covering | | Capacity | |
|---|---|---|---|---|---|
| | of (prepared) | positive electrode | | retention | internal |
| | nonaqueous | mixture layer surface | | rate at | resistance at |
| Bat- | electrolyte | Metal | Com- | 151st Cycle | 101st Cycle |
| tery | (mass %) | oxide | pound A | (%) | (Ω) |
| A1 | 0.25 | Al₂O₃ | TP | 91.6 | — |
| A2 | 0.5 | Al₂O₃ | TP | 89.6 | — |
| A3 | 1.25 | Al₂O₃ | TP | 91.9 | 1.5 |
| A4 | 2 | Al₂O₃ | TP | 90.4 | — |
| B1 | 0 | — | — | 85.0 | 2.0 |
| B2 | 0 | Al₂O₃ | — | 88.5 | 1.3 |
| B3 | 0.5 | — | TP | 83.2 | 4.8 |

The batteries A1 to A4 achieved a higher capacity retention rate than that of the batteries B1 to B3. In the battery B1, the positive electrode mixture layer surface was not covered with any of Al₂O₃ or TP, and therefore the nonaqueous electrolyte was made contact with composite oxide, reducing the capacity retention rate. In the battery B2, the positive electrode mixture layer surface was covered with Al₂O₃, but not covered with TP, and therefore the positive electrode mixture layer coverage was insufficient, and the nonaqueous electrolyte was made contact with composite oxide, reducing the capacity retention rate. In the battery B3, the positive electrode mixture layer surface was covered with TP, but not covered with Al₂O₃, and therefore the internal resistance (positive electrode resistance) increased, reducing the capacity retention rate. In the battery A3, the TP content was greater than that of the battery B3, but the positive electrode mixture layer surface was covered with Al₂O₃, and therefore the internal resistance (positive electrode resistance) decreased than that of the battery B3.

### INDUSTRIAL APPLICABILITY

The nonaqueous electrolyte secondary battery according to the present disclosure is suitably used as, for example, a power supply of a mobile device such as a smart phone, a power source of a vehicle such as an electric vehicle, or a storage device of natural energy such as sunlight.

### REFERENCE SIGNS LIST

1 Electrode Group
2 Positive Electrode Lead
3 Negative Electrode Lead
4 Battery Case
5 Sealing Plate
6 Negative Electrode Terminal
7 Gasket
8 Sealing Plug

1. A nonaqueous electrolyte secondary battery comprising a positive electrode, a negative electrode, and a nonaqueous electrolyte, wherein
the positive electrode includes a composite oxide containing lithium and a transition metal, and an additive covering at least a portion of a surface of the composite oxide, and
the additive includes a metal oxide and a phosphate compound, and
the phosphate compound has at least one intramolecular alkenyl group.

2. The nonaqueous electrolyte secondary battery of claim 1, wherein the alkenyl group includes at least one selected from the group consisting of a vinyl group, a 1-propenyl group, a 2-propenyl group, an isopropenyl group, a 1-butenyl group, a 2-butenyl group, and a 3-butenyl group.

3. The nonaqueous electrolyte secondary battery of claim 1, wherein the phosphate compound includes triallyl phosphate.

4. The nonaqueous electrolyte secondary battery of claim 1, wherein the metal oxide includes at least one element selected from the group consisting of aluminum, silicon, titanium, magnesium, zirconium, niobium, germanium, calcium, and strontium.

5. The nonaqueous electrolyte secondary battery of claim 1, wherein the composite oxide has a layered rock salt type crystal structure, and has a composition represented by a general formula: LiNiₓCo_{y}M_{1-x-y}O₂, in the general formula, 0.323 x<1, 0<y≤0.5 and 0<1-x-y≤0.35 are satisfied, and M is at least one selected from the group consisting of Al and Mn.

6. The nonaqueous electrolyte secondary battery of claim 5, wherein the metal oxide includes Al₂O₃, and
at an outermost surface of the composite oxide covered with the additive, an atomic ratio of Al derived from the metal oxide relative to Ni derived from the composite oxide: Al/Ni is 2 or less.

7. The nonaqueous electrolyte secondary battery of claim 1, wherein the nonaqueous electrolyte contains the phosphate compound by 2 mass % or less relative to the entire nonaqueous electrolyte.
